(19) United States
(12) Patent Application Publication
(10) Pub. No.: US 2004/0002959 A1
(43) Pub. Date: Jan. 1, 2004

(54) Method and system for providing context sensitive support for data processing device user search requests

(75) Inventors: Sherman R. Alpert, Briarcliff Manor, NY (US); Clare-Marie Karat, Greenwich, CT (US); John Karat, Greenwich, CT (US); John G. Vergo, Yorktown Heights, NY (US); Carolyn Ann Brodie, Briarcliff Manor, NY (US)

Correspondence Address: Paul J. Farrell, Esq., DILWORTH & BARRESE, LLP, 333 Earle Ovington Blvd., Uniondale, NY, 11553, US

(73) Assignee: International Business Machines Corporation, Armonk, NY

(21) Appl. No.: 10/180,424

(22) Filed: Jun. 26, 2002

(51) Int. Cl. G06F 17/30

(52) U.S. Cl. 707/3

(57) ABSTRACT

A method for providing search support for searching an information data processing application having searchable elements with associated information is presented, wherein the method includes the steps of accessing a searchable element of the information data processing application, requesting search support while accessing the searchable element, generating a search form having multiple selectable choices in accordance with a subject of the information associated with the accessed searchable element, selecting at least one choice of the search form, and performing a search of the searchable elements using each selected choice as search criteria. Furthermore, a search support system is presented for providing search support for searching an information data processing application having searchable elements with associated information. The search support system includes means for accessing a searchable element of the information data processing application; means for requesting search support while accessing the searchable element; means for generating a search form having multiple selectable choices in accordance with a subject of information associated with the accessed searchable element; means for selecting at least one choice of the search form; and means for performing a search of the searchable elements using each selected choice as search criteria.

### FIELD OF THE INVENTION

The invention relates to the field of support for information searches conducted by users of data processing devices. More specifically, it relates to context sensitive support for information searches conducted by users of data processing device users.

### BACKGROUND OF THE INVENTION

Large amounts of information on a multitude of subjects have become accessible to data processing users via the World Wide Web (WWW or Web) based and non-Web based applications, such as electronic encyclopedias, digital libraries and commercial web-sites. The information is only valuable to a user of a data processing device when the user can locate desired information. Data processing application based search facilities and Internet based search engines have been developed to aid the user in finding and retrieving information related to a specific topic from large amounts of stored information.

Current search methods available include keyword and category methods and combinations thereof. In an article entitled “What's Wrong with Internet Searching”, by Annabel Pollock and Andrew Hockley, D-Lib Magazine, March 1997, available at WWW.dlib.org/dlib/march97/bt/03pollock.html, the authors assert that even for personal computer literate users who were not experienced in Internet use, the process of finding information via search engines was simply too complicated without very high levels of support. The authors further state more recently it has been found that even users claiming to “surf” regularly in the Internet, and having had Internet access for over a year, are still having problems using search engines due to an overabundance of information and an inability to find desired information.

In the keyword method the user enters a keyword, a combination of keywords or a logical expression using keywords. Some search facilities allow the user to reduce the amount of information being searched by providing the user with a plurality of fields for which keywords may be entered. When a user requests a search, the search facility provides the user with a search form having a user entry field in which the user enters a keyword, or logical combination thereof, of the user's choice.

The search facility searches for information entries that include the keyword(s) or satisfy the logical expression. Use of individual keywords is limited, as individual keywords are typically not effective in screening out undesired information. Furthermore, other words synonymous with the keyword(s) used by the user may be included within the information being searched, typically resulting in partial results. In order to effectively use logical combinations of keywords, the user must know how to create a logical expression as well as the syntax used by the particular search facility, which is generally'beyond the capability of the average user.

Furthermore, when requesting a search, a standard search form is provided, regardless of what the user is currently accessing in the application being searched. The search form is fixed, having the same fields and controls, regardless of the context of what the user is currently accessing in the application being searched.

Using category methods the search facility filters out unwanted information by providing the user with a set of pre-selected categories to choose from. The user selects a category, and the search facility provides the user with a reduced, pre-selected list of information entries or subcategories. The category method provides coarse results and provides the user with little control.

Help facilities are often provided with data processing applications such as computer applications to provide the user with solicited or unsolicited help in understanding how to use a feature of the application. Some help facilities are capable of providing context sensitive help in accordance with the user's current or past actions. However, plan recognition techniques used for recognizing the context of the user's actions are the focus of ongoing research and the results are often inadequate. The help facilities provide help specifically by providing suggestions about how to use the data processing application in which the help facility resides. The help facilities are self referential, as they provide suggestions based on information stored by the help facility, and do not provide non-help related information provided from the data processing information application.

A need exists for a method and system for providing context sensitive search support for searching an information application by a user of a data processing device, wherein the search form is generated in accordance with the subject of information the user is currently accessing.

A need further exists for a method and system for providing context sensitive search support for searching, wherein the search support is capable of providing the user with a search form having multiple selectable choices for specifying search criteria, wherein the search form is generated in accordance with the subject of information the user is currently accessing.

A need further exists for a method and system for associating each searchable element of an information application with search criteria data, wherein the search criteria data are used to generate a search form when an element associated with the search criteria data is accessed by a user when requesting search support.

### SUMMARY

An aspect of the present invention is to provide a method and system for providing context sensitive search support for searching an information application by a user of a data processing device, wherein the search form is generated in accordance with the subject of information the user is currently accessing.

It is another aspect of the present invention to provide a method and system for providing context sensitive search support for searching, wherein the search support is capable of providing the user with a search form having multiple selectable choices for specifying search criteria, and wherein the search form is generated in accordance with the subject of information the user is currently accessing.

Finally, it is an aspect of the present invention to provide a method and system for associating each searchable element of an information application with search criteria data, wherein the search criteria data are used to generate a search form when an element associated with the search criteria data is accessed by a user when requesting search support.

Accordingly, the present invention provides a method for providing search support for searching an information data processing application having searchable elements with associated information including the steps of accessing a searchable element of the information data processing application; requesting search support while accessing the searchable element; generating a search form having multiple selectable choices in accordance with a subject of the information associated with the accessed searchable element; selecting at least one choice of the search form; and performing a search of the searchable elements using each selected choice as search criteria.

Furthermore, the present invention provides a search support system for providing search support for searching an information data processing application having searchable elements with associated information. The system includes means for accessing a searchable element of the information data processing application; means for requesting search support while accessing the searchable element; means for generating a search form having multiple selectable choices in accordance with a subject of information associated with the accessed searchable element; means for selecting at least one choice of the search form; and means for performing a search of the searchable elements using each selected choice as search criteria.

### BRIEF DESCRIPTION OF THE FIGURES

The above and other features and advantages of the present invention will become more readily apparent from the following detailed description of the invention, taken in conjunction with the accompanying drawings in which:

FIG. 1 is a flow diagram of process and data flow during a context sensitive search performed by a context sensitive search application in accordance with the present invention;

FIG. 2 is a flowchart of steps performed during a context sensitive search performed by a search application in accordance with the present invention;

FIG. 3 is an exemplary search form generated during a context sensitive search performed by a search application in accordance with the present invention;

FIG. 4 shows another exemplary search form generated during a context sensitive search performed by a search application in accordance with the present invention;

FIG. 5 shows a general page generated by an application to be searched by a search application in accordance with the present invention;

FIG. 6 shows a search form generated in response to a request for search support by the search application, while the general page shown in FIG. 5 is activated, in accordance with the present invention; and

FIG. 7 shows a result form generated by the search application in response to user responses to the search form shown in FIG. 6 in accordance with the present invention.

### DETAILED DESCRIPTION OF THE INVENTION

The present invention provides a method and system for supporting a user of a data processing device to search for information within an information application by providing context sensitive assistance to the user for selecting multiple search criteria for each respective search. The information application, also referred to as an application, is typically an interactive information application, such as an electronic encyclopedia, a digital library, a commercial website promoting sale of multiple items, or the World Wide Web (WWW or Web), that enables a data processing device to store and provide access to information on many subjects associated with individual elements of the application. In the examples described below, the individual elements are pages, such as Web pages written in HyperText Markup Language (HTML) or extensible Markup Language (XML) for a Web based application, however, the elements may be other entities defined by the application's software, such as documents, windows, paragraphs, chapters, images, video clips, subroutines, sections of text, audio clips or graphic files, etc., or a combination thereof. The information associated with the element may be included in the element, or associated with the element such as via a link.

The data processing device is a device such as a personal computer, work station, personal digital assistant, cellular phone, remote control device, consumer electronic device, etc. that is capable of processing data and accessing information via one or more information applications.

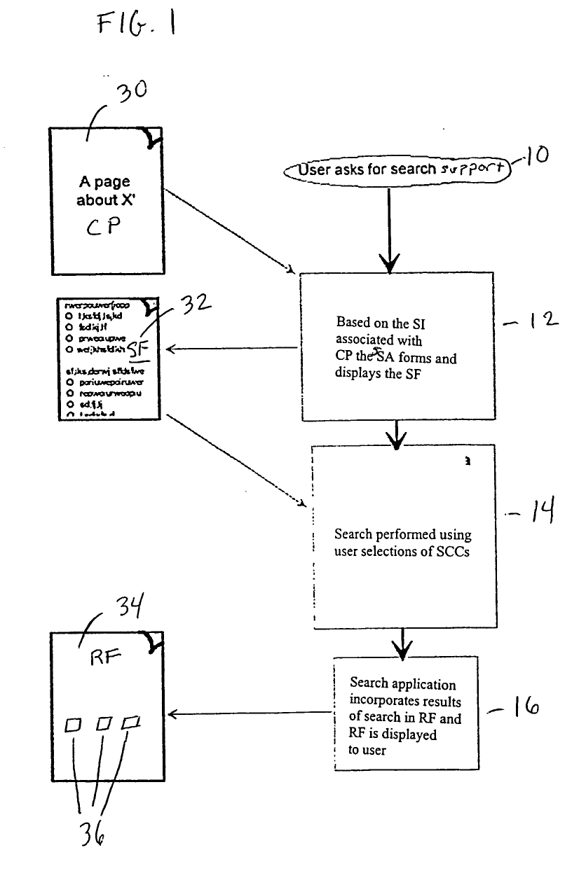

In FIG. 1 a flow diagram shows process steps and data flow resulting from a request by a user of an information application for search support to search for information about subject X. The search support is provided by a search support application (SSA), and the search is provided by a search application (SA). The SSA and SA may reside within or external to the information application. The SSA and SA may run on the same data processing device(s) as the information application or on a different processing device(s). The SSA and SA may operate with one or more compatible information applications, individually or simultaneously. The SSA and SA may provide some or all of the functions of an Internet based search engine.

At the time that the user requests the search support, the user has already accessed an active element including or associated with information about subject X′. In the preferred embodiment the active element is the current page (CP), which is typically the active Web page or current page viewed in the top window. In other embodiments the active element may be an element in an active window or page, such as a segment of text or graphics that is selected or accessed by the user or is pointed at by a position indicator (such as a cursor or pointer) controlled by the user. Alternatively, the user may request search support for beginning a search from a specified element that is not currently accessed, activated or selected but is open. Furthermore, the user may request support search for beginning a search from a specified element that is not open, where the search support application is capable of opening the element.

In the following examples of context sensitive searching, the active element is described as the current page CP, however other active elements may be substituted. The user typically arrived at page CP by navigating or browsing through the application, such as by clicking on a series of one or more links or menu selections, moving through a document or file, or by conducting a previous search. The subject X′ of information associated with page CP is preferably related to subject X as being a superset of subject X. In other embodiments the subject X′ is related to the subject X as a subset of subject X, overlapping subject X, or as being similar, but mutually exclusive to subject X. It is contemplated that the SSA application provides the user with the option to perform a selected type of search, such as a search that searches for a subject X that is: A) a subset of X′, i.e., narrows the scope of the current subject; B) a superset of X′, i.e., broadens the scope of the current subject; or C) overlapping and/or similar but mutually exclusive to subject X′, i.e., searches laterally for a similar or related subject.

While accessing the current page CP, the user requests the search support by performing an action, such as entering a command or clicking on a search support button. Alternatively, the search support is activated automatically by the search support application recognizing that the user is looking for information, where preferably automatic activation of search support may be selectively disabled by the user. For a search support application that provides search support for more than one application at a time, the search support application preferably prompts the user to specify if all applications, all open applications or selected applications should be searched.

In an application being searched, each searchable element of the application has data associated with it including an identifier (a unique name, index number, etc.), search criteria data and information data, where the associated data is stored in records of a database of elements, associated via a link, associated metadata, etc., included in the element or a combination thereof. The information data may be contained within the element itself, i.e., the program code of a web page including text, audio, video, links and/or graphics. For an element constructed of a language such as XML the associated data or a portion thereof may be associated via the language itself.

In another embodiment, the data associated with each searchable element includes a unique identifier, a subject index and information data. The subject index has associated with it search criteria data, where the associated search criteria data is stored in records of a subject database indexed by the subject index, or the search criteria data is associated via a link, associated metadata, etc., or a combination thereof.

With reference to FIG. 1, at step 10 the user requests search support for searching for an element having information about subject X, i.e. having an associated subject index X, in an active application, where the searchable elements of the application are pages. The active element is the current page CP 30 at the time search support is requested. At step 12, the SSA accesses the subject index associated with the active element, current page CP. In the current example the subject index associated with CP is X′.

The SSA accesses search criteria data associated with subject index X′. The SSA uses the accessed search criteria data to build a search form SF 32. The search criteria data preferably includes a list of parameters related to subject X′ along with the possible valid values for each parameter such that the selection of a value or values for one or more of these parameters can be used as the criterion/criteria for searching for other elements that are related to the topic, X′, of CP. Selectable values may have attributes such as arithmetic, character strings, or logical (boolean). Selection of values for these search criteria parameters may result in search operators such as arithmetic, character string and logical operators. The search form SF 32 is provided with a user interface via which the user may select from multiple search criteria choices (SCCs) for searching for a page having an associated subject index X. The search form SF 32 is displayed to the user, for example, as a separate page or window, or as a box or window displayed overlaying a portion or all of the current page CP.

The user selects the search criteria choices desired and initiates the search by performing an action, such as entering a command or clicking a search button, as is known in the art. At step 14, the search application SA uses the search criteria choices selected by the user to perform a search for one or more pages (elements) which meet the selected search criteria choices. The search application and its functions are not within the scope of the present invention, however exemplary uses of the selected search criteria choices are provided for illustration purposes.

Determination, by the search application, of which pages meet the selected search criteria choices (also referred to as matching) may be done, for example, by comparing the selections to metadata associated with the searchable elements, or using the selected criteria choices to form a database query to search a database storing data associated with the searchable elements. The database being searched may be a central information database of the information application that stores data about the searchable elements or the searchable elements themselves. Alternatively, the selected search criteria choices are compared to the element itself when written in a searchable language, such as XML, forming the pages, or via alternative intelligent means. The database query may include arithmetic, character string and logic operators, etc., for performing calculations on SCCs selected by the user and/or the data associated with the searchable elements.

At step 16, the search application SA displays a result form RF 34. This may be a page (element) that includes information resulting from the search, i.e., a page containing all of the information about topic X found by the search application. Alternatively, it may include an entry 36 for each associated page that has information about subject index X. Furthermore, the result form 34 may include both types of information, i.e., central information about topic X as well as links to associated pages with additional information regarding topic X. The entry 36 displayed for each associated page may be textual or graphic, and may contain actual information data associated with each page that matched the selected SCCs and/or means for accessing the information data, such as menu selections, links or addresses. Again, the generation of the result form is not within the scope of the present invention, and discussion pertaining thereto is for illustration purposes.

Thus, the SSA provides support for a context sensitive search by providing customized search forms in accordance with the subject of information being accessed at the time search support is invoked. The SSA may provide support for searching for small amounts of information, such as the answer to a question or a fact, as well as large quantities of information such as web page(s).

Preferably, the SSA provides a proportionately greater amount of search support when the context of the request for search support is more specific, i.e. the subject index associated with the page accessed is more specific, and has a greater amount of associated search criteria.

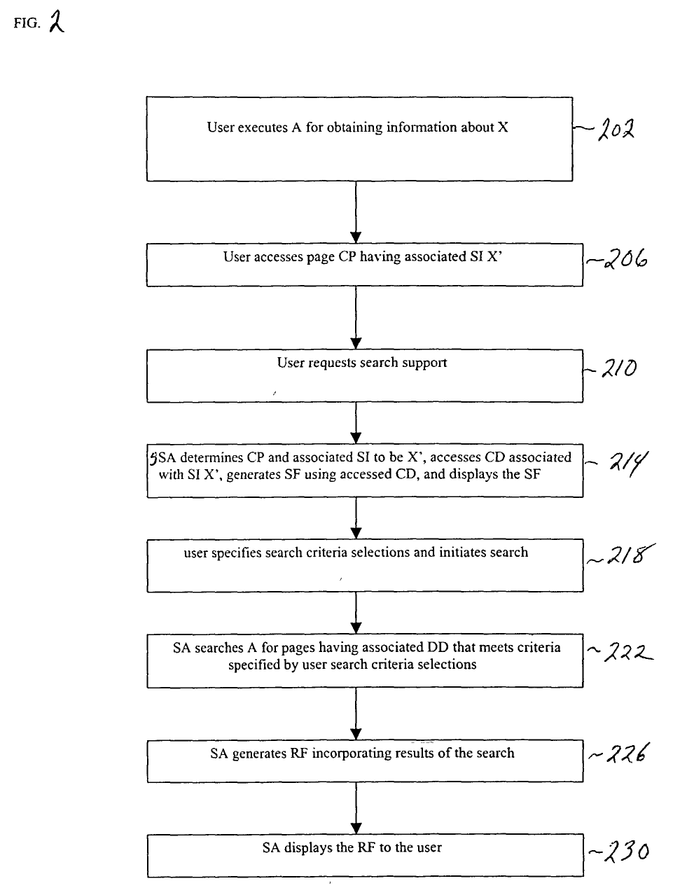

In FIG. 2, flowchart 200 shows a series of user actions and search application actions during a search for information relating to subject index X. At step 202, the user executes application A for obtaining information about subject index X from application A. At step 206, the user accesses page CP having information about subject index X′ which is related to subject index X. Preferably, information about subject index X′ is a superset of information about subject index X. At step 210, the user requests search support for searching for information about subject index X.

At step 214, the SSA determines that the active page in the application A is CP, and that the subject index related to page CP is X′. The SSA accesses search criteria data SCD related to subject index X′, and generates a search form SF including search criteria choices included in the search criteria data related to subject index X′ and displays the search form SF with a user interface that allows the user to make selections. The search criteria choices provide opportunities to the user to make selections that will guide the search application to search for a subject index that is related to subject index X′. In the preferred embodiment, the search application is guided via the user selections to search for a subject index that is a subset of subject index X′.

At step 218 the user makes selections and requests the search, such as by selecting a “DONE” button. At step 222 the search application SA searches for pages that meet criteria specified by the user selections. At step 226 the search application SA builds a result form RF incorporating results of the search. At step 230 the search application SA displays the result form to the user.

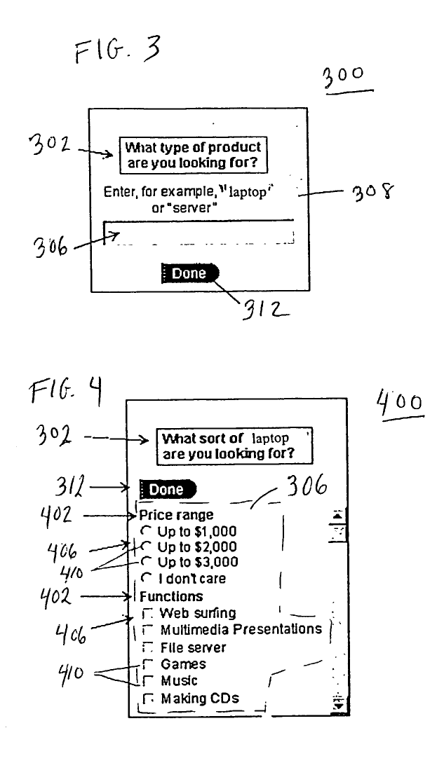

FIG. 3 shows an exemplary search form SF 300 generated by the SSA for a user running a commercial Web site application, and requesting search support while accessing a page having general information about “products”. The search form SF displayed includes a search criteria question 302 such as “What type of product are you looking for?”, a search criteria answer area 306 having an unrestricted text entry field without any guidelines, suggested answers 308, and a “done” button 312 that activates the search using information entered by the user in the search criteria answer area.

FIG. 4 shows another example of a search form SF generated by the SSA, in which the application is an eCommerce Web site of a computer hardware, software and services company, and the user is looking to purchase a laptop computer. The user accesses the website's general product page, and from there links to a general page about laptop computers. The general laptop page displays information about several model lines for dozens of laptop models sold by the company. If the general laptop page is confusing to the use, the user may refine the choices available to her by searching for laptop models that are priced within the user's budget and that have capabilities for running specific types of software applications. In accordance with FIGS. 1-3 above, the user requests search support, for performing a search for laptop models that meet the user's criteria. The request for search support is made, for example, by clicking on a button provided on the general laptop page.

A search form 400 is generated by the SSA and provided to the user. The search form 400 includes a search criteria question 302, a search criteria answer area 306 and a “Done” button 312. The search criteria answer area 306 includes at least one search criteria entry 402. In general, there are one or more criteria entries 402 for which the user may select (specify) values, thereby specifying the criteria for the search. Each search criteria entry 402 has multiple choices 406. Once the user makes selections for the value(s) for one or more criteria entries 402, the user initiates the search, in this example by pressing the “Done” button 312, and the search is performed by the search application based on the user-selected/specified criteria.

As shown in FIG. 4, the choices 406 have associated selection buttons (controls) 410 for allowing the user to select choices. In the example shown, only one choice 406 may be selected for the first search criteria entry 402, and multiple choices 406 may be selected for the second search criteria entry 402. Thus, preferably, for certain criteria, only a single value is valid, while for other criteria multiple choices are valid. The selection buttons 410 may be in the shape of a circle (radio button) and square (check box), to indicate whether a single choice or multiple choices, respectively, are allowed to be made. In the example shown in FIG. 4, only a single selection/choice 406 may be made for the “Price range” search criterion, whereas for the “Functions” search criterion the user may make one or more selections 406.

Thus in order to specify the information or criteria describing what the system should search for, there is no need for the user to, for example, formulate a textual search query involving keywords (or terms) that must be remembered and recalled by the user, along with logical expressions. Search criteria are specified by the selection of (possibly multiple) values 406 for each of one or more criteria entries 402.

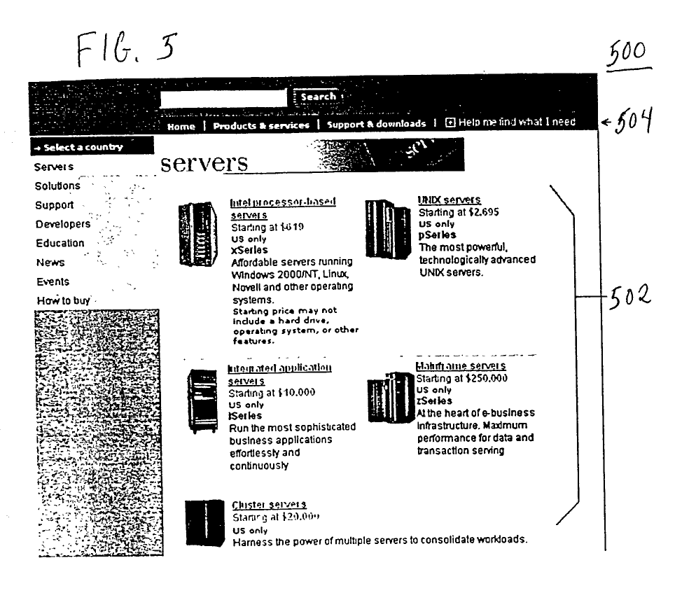

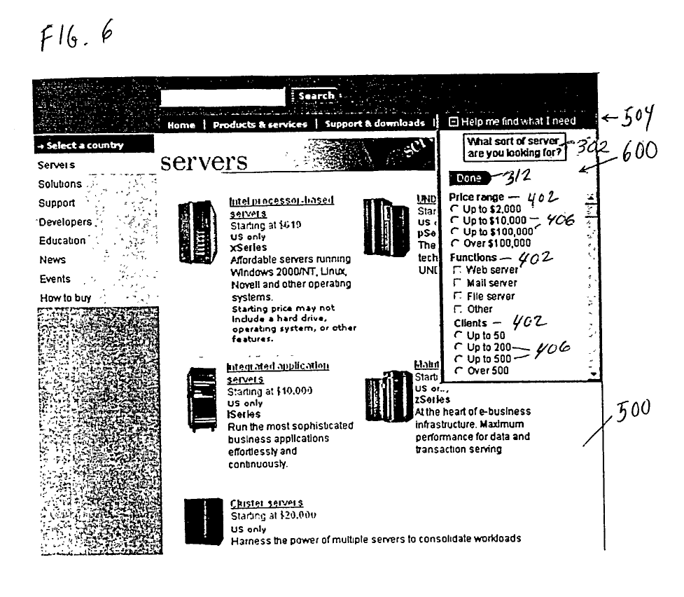

FIG. 5 shows a general page 500 generated by an eCommerce Website about computer servers as accessed by the user. The page displays information 502 about several server families available for purchase through the eCommerce Website. In this example, the subject index X′ associated with the current page, general page 500, is “Servers”. The user is looking for information about subject X, computer servers within a certain price range and having specific capabilities. In order for the user to narrow down the list of servers displayed to a refined list of servers that meet the user's criteria, the user requests search support to search for pages having information about only the servers that meet the user's criteria. The user makes the request for search support by selecting the request-for-search button 504 labeled “Help me find what I need”.

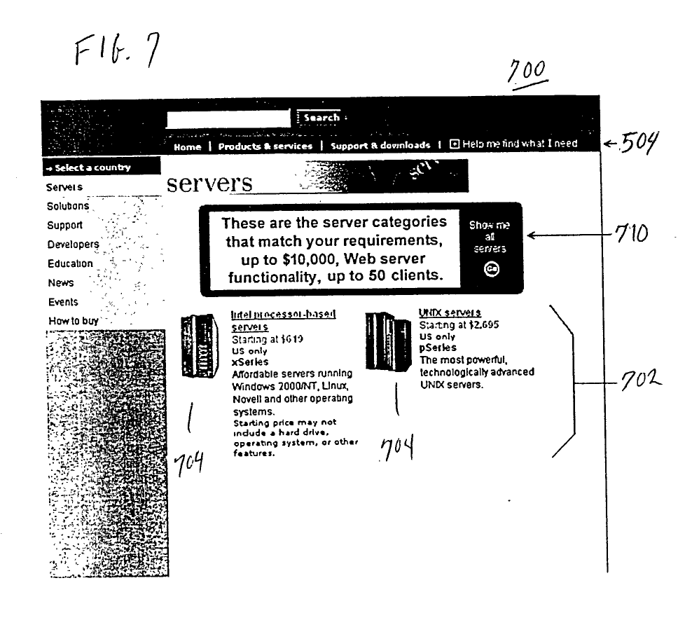

FIG. 6 shows an exemplary search form 600 overlaying window 500. The search form 600 may alternatively replace window 500. Search form 600 was generated and displayed in response to the user's request for search support while accessing page 500. As shown, the search form 600 is different from the search form 400 shown in FIG. 4, since each search form includes a general search criteria question 302 and search criteria entries 402 and respective choices 406 derived from search criteria data associated with the subject index associated with the CP being accessed by the user at the time that the user requested search support. The search support provided by the SSA is thereby context sensitive since it depends on what the user was doing or what element (page) CP the user was viewing at the time that the request for search support was made.

The user selects a choice(s) 406 for desired search criteria 402. Selected search criteria 402 may be mandatory, meaning that that user must make a choice(s). Preferably it is required for the user to select choice(s) 406 for at least one of the search criteria 402 displayed. The search application conducts a search by searching for elements that match the selected criteria choices. For search criteria 402 in which no choices 406 were selected, those search criteria are not included in the search as a search constraint.

The user interface of the search form 600 may include features for allowing the user to enter choices, such as, drop down menus and user entry boxes that restrict user entries to permitted characters or character types. The user entry boxes may include arrows for increasing or decreasing a user entered value or scrolling through permitted entries. It is also contemplated that the search form 600 may include one or more sub search forms. For example, a sub search form is generated and displayed following a user response to a previous sub search form, such that different sub search forms are generated and displayed to the user in accordance with a choice selected in the previous search form.

FIG. 7 shows a result form 700, for illustration purposes, that is generated by the search application and displayed in response to the user-selected search criteria for finding information about X. Once the search application performs the search and finds one or more page records that meet the criteria specified by the choices selected by the user on the search form 600, the search application retrieves the information data associated with each page record found. The information data may include for example the information, a link to the information or an index into a general information database for accessing an entry storing the information.

The result form 700 displays a list 702 of entries 704 corresponding to elements having information about server families that meet the user's search criteria. In the example shown, the entries 704 are links to pages, which may link to pages having information about individual server models that meet the user's search criteria, or may include page addresses. Once the SSA has provided the search criteria choices successfully to the SA, the SSA provides an explanation box 710 that describes the user's selected search criteria which were used to perform the search. The explanation box 710 preferably includes a selectable option to return to a different page, such as the page CP, which in the current example is the page 500 about servers.

In still another embodiment, the result form is presented by opening and displaying one of the pages that meets the user's criteria, and providing the result form as overlaid on the open page. The overlaid result form includes a list 702 of links or addresses to any other pages having an associated subject index that meets the user's criteria.

In the example shown in FIG. 7 the result form 700 is displayed as the active page. In one embodiment, when the result form 700, or other item, such as a box, window or page not associated with a searchable element, is activated by clicking on it or displaying it as the active window, the search button 504 is disabled, preventing the user from performing a search while the result form 700 or other item is the active window.

In summary, the SSA provides context sensitive support to a user for entering search criteria when performing a search of an information application. The SSA may be customized for a variety of information application, where the degree of support and flexibility provided by the SSA may be controlled by an operator who enters the search criteria data during setup of the SSA for a particular information application.

What has been described herein is merely illustrative of the application of the principles of the present invention. Other arrangements and methods may be implemented by those skilled in the art, such as implementing other database configurations, without departing from the scope and spirit of the invention.

In the claims

1. A method for providing search support for searching an information data processing application having searchable elements with associated information, the method comprising the steps of:
accessing a searchable element of the information data processing application;
requesting search support while accessing the searchable element;
generating a search form having multiple selectable choices in accordance with a subject of the information associated with the accessed searchable element;
selecting at least one choice of the search form; and
performing a search of the searchable elements using each selected choice as search criteria.

2. The method of claim 1, further comprising the step of associating each searchable element with search criteria data; and
wherein the generating step includes the steps of:
accessing the search criteria data associated with the accessed searchable element; and
generating the search form in accordance with the accessed search criteria data.

3. The method of claim 1, further comprising the step of generating a search query in accordance with the selected at least one choice.

4. The method of claim 2, wherein the associating each searchable element with search criteria data step includes the step of associating each searchable element with at least one field, each field having multiple choices; and
wherein the generating the search form step includes the steps of:
generating a user interface associated with the search form having an entry corresponding to each field and a choice box associated with each of the multiple choices; and
displaying the user interface associated with the search form.

5. The method of claim 1, wherein the method further includes the step of providing search support for searching a plurality of information data processing applications each having searchable elements with associated information; and
wherein the accessing a searchable element step includes the step of accessing a searchable element of one of the information data processing applications.

6. The method of claim 2, wherein the search criteria data is capable of including at least one operator.

7. A search support system for providing search support for searching an information data processing application having searchable elements with associated information, the system comprising:
means for accessing a searchable element of the information data processing application;
means for requesting search support while accessing the searchable element;
means for generating a search form having multiple selectable choices in accordance with a subject of information associated with the accessed searchable element;
means for selecting at least one choice of the search form; and
means for performing a search of the searchable elements using each selected choice as search criteria.

8. The search support system of claim 7, further comprising:
means for associating search criteria data with each searchable element;
means for accessing the search criteria data associated with the accessed searchable element; and
means for generating the search form in accordance with the accessed search criteria data.

9. The search support system of claim 7, further comprising means for generating a search query in accordance with the selected at least one choice.

10. The search support system of claim 8, wherein the search criteria data associated with each searchable element includes at least one field, each field having multiple choices, the system further comprising:
means for generating a user interface associated with the search form having an entry corresponding to each field and a choice box associated with each of the multiple choices; and
means for displaying the user interface associated with the search form.

11. The search support system of claim 7, further comprising:
means for providing search support for searching a plurality of information data processing applications each having searchable elements with associated information; and
means for accessing a searchable element of one of the information data processing applications.

12. The search support system of claim 7, further comprising:
means for associating a subject index with each searchable element;
means for associating search criteria data with each subject index corresponding to the searchable element;
means for accessing the search criteria data associated with the subject index associated with the accessed searchable element; and
means for generating the search form in accordance with the accessed search criteria data.

13. The search support system of claim 8, wherein the search criteria data is capable of including at least one operator.

14. A program storage device readable by a machine, tangibly embodying a program of instructions executable by the machine to perform method steps for providing search support for searching an information data processing application having searchable elements with associated information, the method comprising the steps of:
accessing a searchable element of the information data processing application;
requesting search support while accessing the searchable element;
generating a search form having multiple selectable choices in accordance with a subject of the information associated with the accessed searchable element;
selecting at least one choice of the search form; and
performing a search of the searchable elements using each selected choice as search criteria.
